(19) United States
(12) Patent Application Publication
(10) Pub. No.: US 2025/0179856 A1
(43) Pub. Date: Jun. 5, 2025

(54) IMMINENT MOTION NOTIFICATION SYSTEMS AND METHODS FOR BARRIER OPERATORS

(71) Applicant: GMI Holdings, Inc., Mt. Hope, OH (US)

(72) Inventors: Brent A. Rauscher, Keller, TX (US); Linga Swamy Pagudala, Little Elm, TX (US); Tom Deneen, Akron, TX (US); Mahidhar Nandigam, Dallas, TX (US); Sri Gouru, Carrollton, TX (US)

(21) Appl. No.: 18/529,601

(22) Filed: Dec. 5, 2023

(51) Int. Cl. E05F 15/668; E05F 15/77

(52) U.S. Cl. CPC E05F 15/668; E05F 15/77; E05Y 2400/65; E05Y 2900/106

(57) ABSTRACT

Systems, devices, and methods for performing an imminent motion notification in relation to movement of a barrier. A barrier operator system includes a barrier operator and a server. The barrier operator includes a motor configured to manipulate a barrier, an alert module, and one or more processors configured to control the motor and the alert module. The server receives a message from a remote user device indicating a request to move the barrier and sends an imminent motion notification command to the barrier operator. The barrier operator performs, in response to receipt of the imminent motion notification command, an imminent motion notification and sends an acknowledgement signal to the server indicating that the imminent motion notification has been performed. The server sends, in response to receipt of the acknowledgement signal, a barrier movement command and the barrier operator operates the motor to execute the barrier movement command.

### FIELD

The present disclosure is directed to remotely controlled barrier operator systems for opening and closing garage doors, gates, and other moveable barriers, and more particularly to systems and methods for providing an imminent motion notification when remotely controlled movement of a barrier is imminent.

### BACKGROUND

With few exceptions, barrier operators, such as those controlling upward acting sectional garage doors, rollup doors, gates, and other motor operated barriers, may be locally controlled. Barrier operators may be locally controlled by one or more wired or wireless mounted or hand-held transmitters located within visual range of the barrier.

However, some barrier operators may also be remotely controlled by remote user devices like smartphones which may be located distant from the location of the barrier. Because a user may operate the barrier from virtually anywhere, the user may not know or be able to visually confirm whether a person is near the barrier when they command the barrier operator to move the barrier. Thus, it is advantageous for the barrier operator system to provide an alert in the form of an imminent motion notification, which may include activating a light and/or emitting a sound, to provide notice to those near the barrier that the barrier may soon move.

However, it may be desirable to omit an imminent motion notification when a user locally commands the barrier operator to move the barrier. In this case, the user is within a certain distance (e.g., wireless range of a hand-held transmitter) of the barrier operator and, thus, can visually confirm the path of the barrier is unobstructed. For this reason, it is typical for an imminent motion notification to be provided when a barrier movement command is sent by a remote transmitter and for no imminent motion notification to be provided when a barrier movement command is sent by a local transmitter. Furthermore, it some instances, it may be desirable to provide an imminent motion notification only for movements of a barrier in a close direction.

In some barrier operator systems, a barrier operator may analyze or process barrier movement commands to determine their source (e.g., remote transmitter or local transmitter) and, in turn, determine whether an imminent motion notification should be provided. For various reasons, it may be desirable to simplify the operations performed by the barrier operator and eliminate the need for the barrier operator to determine, for each received door movement command, whether to provide an imminent motion notification.

### SUMMARY

Consistent with an aspect of the present disclosure, a barrier operator for moving a barrier may be configured to: receive an imminent motion notification command from a server; perform an imminent motion notification; send an acknowledgement signal to the server indicating that the imminent motion notification system has been performed; receive a barrier move command from the server; and move the barrier.

In an aspect of the present disclosure, a barrier operator for manipulating a barrier may be configured to: receive an imminent motion notification command from a server; perform an imminent motion notification; in response to completing the imminent motion notification, send an acknowledgement signal to the server indicating that the imminent motion notification has been performed; after sending the acknowledgement signal, receive a barrier movement command from the server; and in response to receiving the barrier movement command, move the barrier.

In some examples, the barrier operator may be further configured to assess, after receiving the imminent motion notification command from the server, whether a commanded movement of the barrier is performable. The barrier operator may be further configured to send an indication of a result of determining whether the commanded movement of the barrier is performable to the server. The barrier operator may be configured to send the indication prior to or simultaneously with performing the imminent motion notification.

In some examples, the barrier operator may be configured to assess whether the commanded movement of the barrier is performable by evaluating whether an obstruction is detected by an optical sensor. Additionally or alternatively, the barrier operator may be configured to asses that the commanded movement of the barrier is performable by verifying the barrier operator is not in an error state and/or by verifying that the barrier is in a position that will allow execution of the commanded movement.

In some examples, the commanded movement of the barrier may be transitioning from an open position to a closed position.

In some examples, the barrier operator may be further configured to assess, after receiving the barrier movement command, whether a commanded movement of the barrier is performable and send an indication of a result of determining whether the commanded movement of the barrier is performable to the server.

In some examples, the barrier operator may be configured to communicate with the server over a wireless network via an internet router.

In some examples, the barrier operator may include a barrier control module and a barrier controller. The barrier control module may include at least one first processor and may be configured to communicate with the server. The barrier controller may include at least one second processor configured to control movement of the barrier. The at least one first processor may be configured to command the at least one second processor perform the imminent motion notification. The barrier operator may include a housing. The barrier control module and the barrier controller may be disposed within the housing.

In some examples, the barrier operator may be configured to, after moving the barrier, transmit a signal to the server indicating that a commanded movement of the barrier has been completed.

In an aspect of the present disclosure, a server may be in communication with a barrier operator. The server may be configured to receive a message from a remote user device indicating a request to move a barrier controlled by the barrier operator and send an imminent motion notification command to the barrier operator in response to receipt of the message from the remote user device. The server may be configured to receive an acknowledgement signal from the barrier operator indicating the imminent motion notification has been performed and send a barrier movement command to the barrier operator in response to receiving the acknowledgement signal.

In some examples, the server may be configured to initiate a time-out function in response to sending the imminent motion notification command. The time-out function may include a predefined period of time. The server may be configured to discard the barrier movement command, without sending the barrier movement command to the barrier operator, if the acknowledgement signal is not received within the predefined period of time.

In an aspect of the present disclosure, a barrier operator system includes a barrier operator and a server. The barrier operator may include a motor configured to manipulate a barrier, an alert module, and one or more processors configured to control the motor and the alert module. The barrier operator system may be configured to: receive, at the server, a message from a remote user device indicating a request to move the barrier; send, by the server, an imminent motion notification command to the barrier operator; perform, by the barrier operator in response to receipt of the imminent motion notification command, an imminent motion notification; send, by the barrier operator, an acknowledgement signal to the server indicating that the imminent motion notification has been performed; send, by the server in response to receipt of the acknowledgement signal, a barrier movement command to the barrier operator; and operate, by the barrier operator, the motor to execute the barrier movement command.

In some examples, the barrier operator may be configured to assess, before executing the imminent motion notification command, that a commanded movement of the barrier is performable. The barrier operator may be configured to transmit to the server, after executing the barrier movement command, a signal indicating that the barrier has been moved.

Other examples include corresponding methods, computer systems, apparatuses, devices, and instructions recorded on one or more computer-readable storage mediums, each related to the functions described herein.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a perspective view of an installed barrier operator system in accordance with an example of the present disclosure.

FIG. 2 is a block diagram of a barrier operator system in accordance with an example of the present disclosure.

FIG. 3 is a flow chart illustrating the operation of the barrier operator in accordance with an example of the present disclosure.

FIG. 4 is a flow chart illustrating an example method of operation of a barrier operator in accordance with an example of the present disclosure.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The devices and techniques disclosed in this document may be used to provide an imminent motion notification in a barrier operator system.

In the following description, like elements are marked throughout the specification and drawings with similar reference numerals. The drawing figures are not necessarily drawn to scale and certain elements are shown in generalized or schematic form in the interest of clarity and conciseness. It should be understood that the embodiments of the disclosure herein described are merely illustrative of the principles of the invention.

In modern barrier operator systems, while uses may locally control a barrier operator with traditional transmitters such as a wall mounted wired or wireless button or a hand-held radio frequency (“RF”) remote, users are also able to remotely control a barrier operator to initiate barrier movements and receive barrier status information through a remote user device, such as a smartphone or computer. The remote user device use may use a wireless and/or wired network connection to communicate with one or more servers (“cloud processing platform”). The server system, in turn, is in wired and/or wireless communication with the barrier operator through an Internet connection. In many instances, a barrier operator may communicate in a local wireless network via a router. In this way, a user may be able to use the remote user device to obtain barrier status information, such as whether the barrier is open or closed, and/or command the barrier operator to move the barrier. It should be appreciated that the term “command” as used herein may be used interchangeably with request, instruct, or like terms. It should be appreciated that sending a barrier movement command may not necessarily result in the commanded movement occurring, as the server and/or the barrier operator may institute one or more system status assessments as a condition of executing the command, as discussed further below.

When initiating a barrier movement command through a user interface of a remote user device, a user could theoretically be located anywhere in the world with an internet connection and may not have visual contact with the barrier to assess if a path of the barrier is obstructed. Thus, the barrier operator system may provide an imminent motion notification (“IMN”) to alert people in the vicinity of the barrier that the barrier will soon begin moving. The IMN may include an alert module within or in operative communication with the barrier operator activating a light and/or a sound emitter to provide notice to people close to the barrier that the barrier is about to move. Rules and regulations in various regions may govern that such an IMN be provided for remotely initiated close commands, open commands, or both.

Oftentimes, an IMN need not be performed if the user locally commands barrier movement. For example, if the user is commanding barrier movement via a wall console or an RF transmitter, it may be inferred that the user is within close proximity of the barrier and can verify the path of the barrier is unobstructed. For this reason, some barrier operators may analyze a received barrier movement command to determine the origin of the command and may perform an IMN when the barrier operator determines the command originated from a remote source. This process can require complex signaling schemes with embedded origin indicators and could potentially result in movement of a barrier in response to a remotely generated command without performing an IMN.

Accordingly, the present disclosure contemplates systems and methods for performing an IMN before moving a barrier in response to a remotely generated barrier movement command which may alleviate issues present in existing barrier operator systems. Systems and methods of the present disclosure may utilize separate and discrete commands for: 1) performing an IMN; and 2) initiating movement of the barrier. The commands may be separated both temporally and functionally.

As an example of operation of a barrier operator system of the present disclosure, a user may access a user interface on a remote user device and obtain a current status of a barrier, for example, whether the barrier is open or closed. The user may provide an indication that the user desires the barrier to be moved by providing an input via the remote user device. For example, the user may press a button presented on a graphical user interface, press a physical button on the remote user device, provide a voice command, etc. The remote user device may then transmit a message to the cloud processing platform indicating that the user has requested movement of the barrier. In response to receipt of the message from the remote user device, the cloud processing platform may generate and transmit an IMN command to the barrier operator. Optionally, the cloud processing platform may also generate, but retain, a barrier movement command. That is, the cloud processing platform may buffer the barrier movement command for later transmission.

Upon receipt of the IMN command, the barrier operator may perform one or more system status assessments related to barrier movement. For example, the barrier operator may assess, via signals received from a sensor, whether an obstruction is currently preventing movement of the barrier. As another example, the barrier operator may assess whether it has detected an error state (e.g., power supply issue, motor temperature anomaly, alert module not functioning properly). A result of the one or more system status assessments may be transmitted to the cloud processing platform. If there are no detected issues preventing the commanded movement of the barrier, the barrier operator may perform the IMN via the alert module. Upon completion of the IMN, the barrier operator may send an acknowledgement signal to the cloud processing platform indicating that the IMN has been performed.

In response to receiving the acknowledgement signal from the barrier operator, the cloud processing platform may then send the barrier movement command to the barrier operator which the barrier operator will execute if it is presently able to do so (e.g., no detected issues preventing the movement). If the acknowledgement signal is not received by the cloud processing platform, or if it is received after a defined period of time has elapsed from when the IMN command was sent, the cloud processing platform will abort the barrier movement and refrain from sending a door movement command. Examples of barrier operator systems, including cloud processing platforms, barrier operators, and remote user devices, in accordance with the present disclosure are discussed below in relation to the figures.

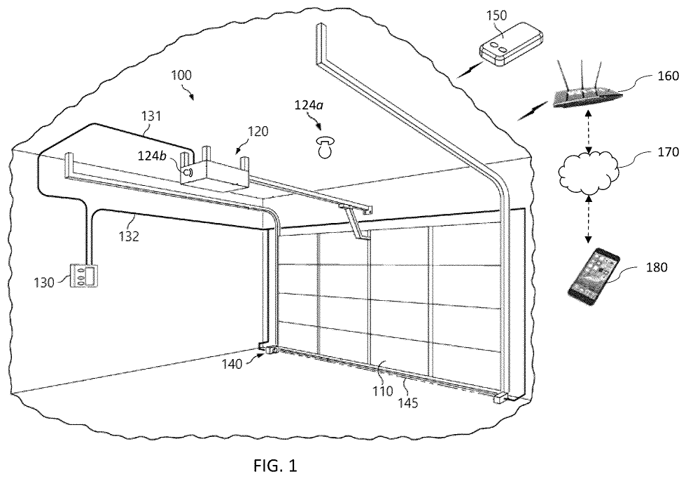

FIG. 1 illustrates example components of a barrier operator system 100 positioned at a user premises. In the illustrated example, the barrier 110 is an upward-acting sectional garage door movable between a closed position shown and an open position. Barrier 110 is movable between its open and closed positions by a barrier operator 120, shown as a ceiling-mounted motor driven garage door operator. It should be appreciated that the present disclosure is not limited to upward-acting sectional garage doors and ceiling-mounted garage door operators. In some examples, the barrier 110 may be a sliding or rolling gate and the barrier operator 120 may be gate opener. In other examples, the barrier operator 120 may be a wall-mounted jackshaft type door operator. For an example of components that may be included in the barrier operator 120, see U.S. Pat. App. Pub. No. 2020/0340288, which is incorporated by reference herein in its entirety.

Barrier operator 120 is operably connected to a wall console 130 mounted on a wall. Barrier operator 120 and console 130 are in operative communication via wired conductor 131, although wireless transmission is also suitable. One or more buttons on the wall console 130 may be configured to transmit a door movement command to the barrier operator 120. A hand-held (or vehicle-mounted) transmitter 150 may transmit door movement commands to the barrier operator 120 via a suitable RF channel. Because the wall console 130 is locally disposed and the remote transmitter 150 has a relatively limited transmission range, given that it communicates directly with the barrier operator 120 rather than through a network, it may generally be assumed that door movement commands from the wall console 130 and transmitter 150 are locally generated.

Barrier operator 120 may configured to connect to a wireless network, such as Wi-Fi, provided by a router 160 and thus may receive and/or transmit signals to/from the router 160 over the wireless network. The router 160 may be connected to a cloud processing platform 170 via a wired or wireless network which may include the internet. The cloud processing platform 170 may comprise one or more servers, such as cloud servers. In some examples, the one or more servers may be dedicated barrier operator servers maintained by a barrier operator service provider, such as a barrier operator manufacturer. A remote user device 180 may be in operative communication with the cloud processing platform 170 via a wired or wireless internet connection, such as via a mobile network. Thus, the remote user device 180 is in operative communication with the barrier operator 120, for example via the cloud processing platform 170 and the router 160. The remote user device 180 may be a smartphone or computer. The barrier operator system 100 also includes an alert module 124. The alert module 124 may include one or more lights and/or sound emitters. The alert module 124a may be a distinct apparatus dedicated to performing imminent motion notifications. The alert module 124a may be external to the barrier operator 120 and may be in wired or wireless communication with the barrier operator 120. For example, the alert module 124a may communicate with the barrier operator 120 via a Wi-Fi or Bluetooth connection. The alert module 124b may be internal to the barrier operator 120 such that the alert module 124b is disposed within the housing of the barrier operator 120.

The barrier operator system 100 also includes a sensor device 140. In the illustrated example, the sensor 140 is positioned adjacent to the barrier 110 and includes an optical or infrared beam transmitter disposed on one side of the aforementioned doorway and a receiver disposed on the opposite side. Such a device is commonly referred to as a “safety beam” or “photo eye.” The sensor 140 is operable to send a signal to the barrier operator 120, either directly or by way of the console 130 as illustrated, via a wired conductor 132 or wireless transmission. Such a signal may indicate to the barrier operator 120 when an obstruction breaks the beam 145 between the transmitter and receiver of the sensor 140.

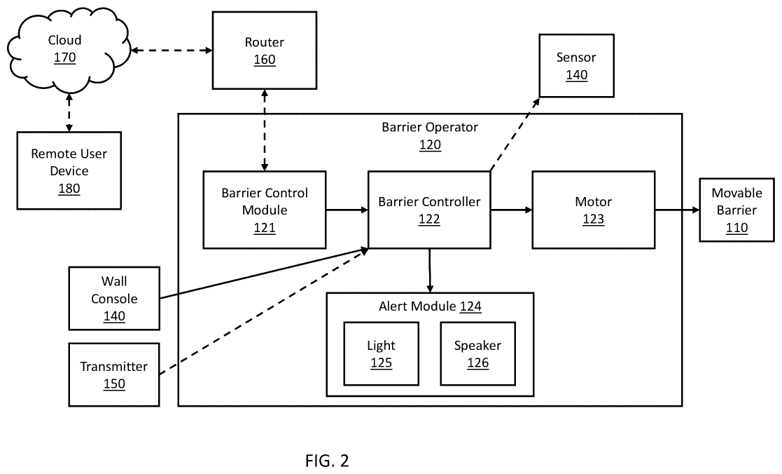

FIG. 2 illustrates a schematic diagram of components of the barrier operator system 100. The barrier operator 120 may include a barrier control module 121 and a barrier controller 122. The barrier control module 121 and the barrier controller 122 may be discrete modules, embodied in software, hardware, or both, configured to perform particular functions of the barrier operator 120 described herein. In some examples, the barrier control module 121 and barrier controller 122 may be integrated into a single module.

In the illustrated example, the barrier control module 121 handles network communication. The barrier control module 121 may include a Wi-Fi transceiver and one or more processors. For example, a first processor of the barrier control module 121 may control the Wi-Fi transceiver and a second processor of the barrier control module 121 may interface with the barrier controller 122 to send and receive communications therebetween. As illustrated, the barrier control module 121 and the barrier controller 122 are both disposed within a common housing of the barrier operator 120. In some examples, the barrier control module 121 may be external to the housing of the barrier operator 120 and may communicate with the barrier controller 122, by wired or wireless communication. For example, the barrier control module 121 may be housed with the wall console 130 or located elsewhere in the system 100.

The barrier controller 122 is tasked with operation of the motor 123, alert module 124, and various other components of the barrier operator 120 (some of which are not shown to avoid obfuscating the present disclosure). As limited examples, the barrier controller 122 may interface with the wall console 130, the sensor device 140, an RF receiver configured to receive communications from the transmitter 150, and/or a motor shaft encoder or other position sensor device. The barrier controller 122 may monitor a status of the barrier 110 and transmit status information to the barrier control module 121 network transmission to the cloud processing platform 170 and, in turn, the remote user device 180. The barrier controller 122 may also perform system status assessments to evaluate whether a commanded movement of the barrier 10 is performable (e.g., there are no detected issues preventing the movement from being executed). In some examples, the barrier controller 122 may detect an anomaly in one or more drive components (e.g., excessive motor torque indicating a track may be bent or a roller stuck) or the alert module 124 (e.g., light bulb inoperative) indicating that the movement cannot be executed, or it may detect an obstruction via the sensor device 140.

Although the alert module 124 in FIG. 2 is shown as being internal to the barrier operator 120, it should be understood that an alert module 124 may be located externally to the barrier operator 120, as described above. The alert module 124 may include one or more lights 125 and/or sound emitters 126. The alert module 124 may be a distinct apparatus dedicated to performing imminent motion notifications. As conventional barrier operators often include a light 125 and/or a speaker 126 for illuminating an area around the barrier operator and visually conveying status information to a user, the alert module 124 may include the conventional light 125 and/or speaker 126 of the barrier operator. In this regard, the barrier controller 122 may be configured to operate such a light 125 and/or speaker 126 both for conventional purposes and for IMN commands received from the cloud processing platform 170. The IMN commands may be routed through the barrier control module 121 to the barrier controller 122. In some implementations, the barrier control module 121 may be in direct communication with the alert module 124. Although illustrated as an integral component of the barrier operator 120, it should be appreciated that in some examples the alert module 124 may be disposed external to the housing of the barrier operator 120. For example, a remote alert module may be mounted near a walk-through door in a user's garage and may be in wired or wireless communication with the barrier control module 121 or barrier controller 122. The alert module 124 may be configured to perform an IMN to notify people in the vicinity of the barrier 110 that movement of the barrier 110 is imminent. The IMN may include, for example, flashing one or more lights, emitting an audible noise, a combination of both, or any other suitable means to convey that movement of the barrier will soon occur.

As indicated above, the barrier control module 121 may configured to connect to a wireless network, such as Wi-Fi, provided by router 160 and thus may receive and/or transmit signals to/from the router 160 over the wireless network. In some embodiments, the barrier control module 121 may perform one or more system status assessments or may command the barrier controller 122 to perform one or more system status assessments.

The router 160 may be connected to the cloud processing platform 170 via a wired or wireless network which may include the internet. The cloud processing platform 170 may comprise one or more servers, such as cloud servers. In some examples, the one or more servers may be dedicated barrier operator servers maintained by a barrier operator service provider, such as a barrier operator manufacturer. The remote user device 180 may be in operative communication with the cloud processing platform 170 via a wired or wireless internet connection, such as via a mobile network. Thus, the remote user device 180 is in operative communication with the barrier operator 120, for example via the cloud processing platform 170 and the router 160.

In some examples, all barrier movement commands, whether originating locally from the wall console 130 and transmitter 140 or remotely from the cloud processing platform 170, are ultimately received at the barrier controller 122 which then activates the motor to move the barrier. Conversely, only remotely generated barrier movement commands from the cloud processing platform 170 are received by the barrier control module 121.

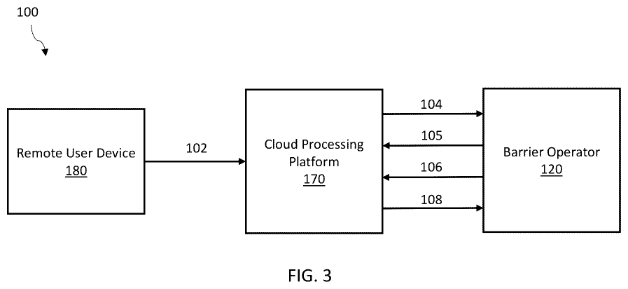

FIG. 3 graphically illustrates an example of communication in barrier operator system 100 in relation to executing a remotely generated barrier movement command from the remote user device 180. The remote user device 180 may present a user interface to the user via a display. The user interface may be generated by an application executed on the remote user device 180 or may be generated by the cloud processing platform 170 and presented on the display via a portal. A user may provide an input via the user interface indicating a request 102 to initiate movement of the barrier. The cloud processing platform 170 may validate the barrier movement request 102. For example, the cloud processing platform 170 may verify access permissions of the user, the user device, or both.

In response to receiving the barrier movement request 102, the cloud processing platform 170 generates an IMN command 104 and transmits the IMN command 104 signal to the barrier operator 120. The IMN command 104 instructs the barrier operator 120 to perform an IMN. Upon receipt of the IMN command 104 signal, the barrier operator 120 may perform one or more system status assessments regarding whether or not the commanded movement is performable. Upon completing the assessments, the barrier operator 120 may transmit a status update 105 signal to the cloud processing platform 170. The status update 105 may indicate that the barrier operator 120 will proceed with performing the IMN or may provide an indication that an anomaly has been detected and include an identification of the anomaly, as described above. For example, the barrier controller 122 may detect excessive motor torque indicating a track may be bent or a roller stuck, a light bulb is inoperative, or an obstruction via the sensor device 140.

If the status update 105 indicates an anomaly, the cloud processing platform 170 will cancel the barrier movement command 108 (e.g., delete it from the buffer or refrain from generating it if it has not yet been generated). In some examples, the barrier operator 120 may be configured to routinely perform the one or more system status assessments such that the status update 105 signal may be transmitted promptly upon receipt of the IMN command 104. If there are no detected issues, the barrier operator 120 will transmit the status update 105 signal to the cloud processing platform 170 indicating that the IMN is performable and will then perform the IMN in response to receipt of the IMN command 104. In some examples, the barrier operator 120 may validate the IMN command 104 prior to performing the IMN. For example, encrypted data in the IMN command 104 may be decrypted by the barrier operator 120.

Upon completion of the IMN, the barrier operator 120 will transmit an acknowledgement signal 106 to the cloud processing platform confirming that the IMN has been performed. In response to receiving the acknowledgement signal 106, the cloud processing platform 170 transmits a barrier movement command 108 signal to the barrier operator 120 instructing the barrier operator 120 to execute the barrier movement. The barrier operator 120 may repeat the one or more system status assessments upon receipt of the barrier movement command 108 signal. In some examples, the barrier operator 120 may perform the one or more system status assessments only upon receipt of the barrier movement command 108 signal. Further, in some examples, the barrier operator 120 may validate the barrier movement command 108 prior to activating the motor to move the barrier. If the system status assessments indicate the commanded movement cannot be performed, or if the barrier movement command 108 cannot be validated, the barrier operator 120 rejects the door movement command 108.

The barrier movement request 102, the IMN command 104, and/or the barrier movement command 108 may include information associating the communications with the remote user device 180 and/or with the particular barrier movement request 102. For example, one or more of these communications may include a request ID that associates the correspondence with the specific barrier movement request 102. The cloud processing platform 170 may maintain a database recording each transmission sent and received and a timestamp associated with each.

In some cases, the IMN may be performed for a predefined period of time. For example, the IMN may be performed for 1 second, 5 seconds, or 30 seconds. In this regard, it may be expected that the cloud processing platform 170 will not receive the acknowledgement signal 106 indicating that the IMN has been completed for at least the predefined period of time. In some examples, the cloud processing platform 170 will not generate the barrier movement command 108 until after the acknowledgement signal 106 has been received. In some examples, the cloud processing platform 170 will generate the barrier movement command 108 simultaneously with or shortly after generating the IMN command 104, but it will retain the barrier movement command 108 in a buffer to be sent only after the acknowledgment signal 106 has been received. During this time between sending the IMN command 104 signal and sending the door movement command 108 signal, the cloud processing platform 170 may execute a time-out function corresponding to the predefined period of time. If an acknowledgement signal 106 is received before the period of time has elapsed following transmission of the IMN command 104 signal, the cloud processing platform 170 may assume an error has occurred and cancel the barrier movement command 108. That is, receiving the acknowledgement signal 106 before the predefined period of time has elapsed may indicate that IMN was not performed or was not performed for a sufficient amount of time. Conversely, receipt of the acknowledgement signal 106 well after the predefined period of time has elapsed since transmission of the IMN command 104 signal may indicate communication delays or other impermissible delay following performance of the IMN. That is, movement of the barrier should occur immediately or shortly after the IMN has been performed to effectively notify people in the vicinity of the barrier of the imminent barrier movement. If the timer of the time-out function expires before receipt of the acknowledgement signal 106, the cloud processing platform 170 will cancel the barrier movement command 108.

The timer of the time-out function may include an amount of acceptable delay to account for minor delays in generating and transmitting the communications. For example, if the predefined period of time for which the IMN is to be performed is 5 seconds, the timer of the time-out function executed by the cloud processing platform 170 may allow for 6 seconds to elapse (or 30 seconds, 1 minute, etc. as appropriate) between transmitting the IMN command 104 and receiving the acknowledgement signal 106. Any other suitable cushion may be incorporated into the timer.

It will be understood that the IMN command 104 signal is received by the barrier control module 121 (FIG. 2). It is then processed by the barrier control module 121, which then instructs the barrier controller 122 or alert module 124 to perform the IMN. The barrier controller 122 or alert module 124 must then signal to the barrier control module 121 that the IMN has been performed and, in turn, the barrier control module 121 then sends the acknowledgement signal 106 to the cloud processing platform 170.

In some embodiments, execution of the barrier movement command 108 may result in the barrier operator 120 returning a confirmation signal to the cloud processing platform 170 confirming the barrier movement has occurred successfully. This information may then be presented to the user via the remote user device 180. In some examples, the barrier operator 120 may be configured to routinely transmit door position information (e.g., periodically at defined intervals or upon each door movement regardless of the origin of the command) such that barrier operator 120 will transmit the updated door position information in due course.

If the barrier move request 102 was not able to be fully implemented (i.e., the IMN was not performed, the barrier 110 was not moved, or the movement was interrupted), a notification may be transmitted to the remote user device 180 via the could processing platform 170.

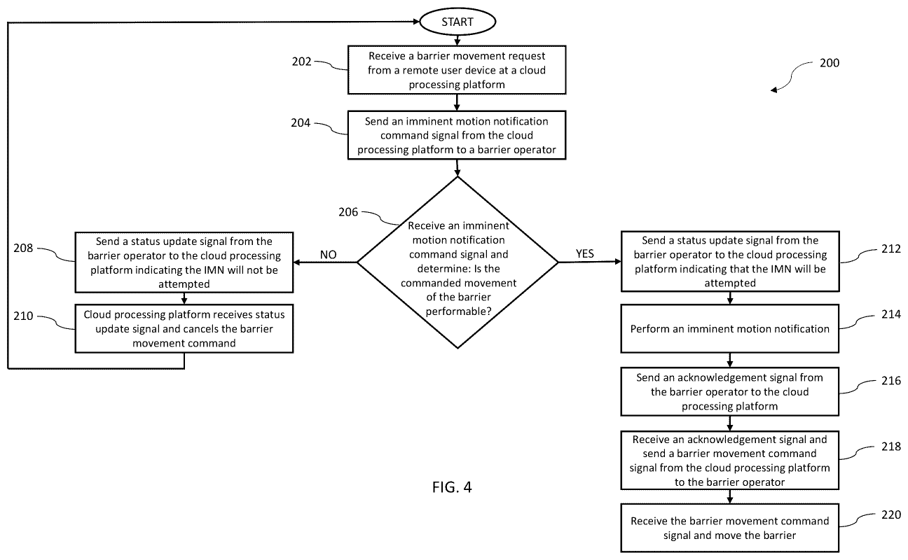

FIG. 4 illustrates a flow chart of a method 200 for implementing a request to move a barrier generated through a remote user device. At process 202, a cloud processing platform, such as cloud processing platform 170, receives a barrier movement request signal initiated by a user at a remote user device, such as remote user device 180. The barrier movement request indicates that the user has instructed movement of the barrier from its current position (e.g., open or closed). At process 204, in response to receiving the barrier movement request signal, the cloud processing platform generates and sends an IMN command signal to the barrier operator instructing the barrier operator to perform an IMN command. At process 206, the barrier operator receives the IMN command signal and performs system status assessments to confirm whether the commanded movement of the barrier is performable. As described herein, the system status assessments may identify whether the operator is in a condition to execute the command. For example, obstructions in the doorway opening or in the pathway of a gate may indicate that the operator is not in a condition to execute the command. Other examples are described herein.

At process 208, if the status update identifies reasons or flags that indicate the IMN or the commanded movement cannot be performed, the barrier operator will send a status update signal to the cloud processing platform indicating that the commanded movement is not performable and that the barrier operator will not attempt to perform the IMN. At process 210, the cloud processing platform will abort the movement and cancel the barrier movement command. This information also may be transmitted back to the remote user device to keep the user informed and to provide an indication that alternative action or service would be necessary before the door would move.

At process 212, if there are no anomalies preventing operation of the barrier movement, the barrier operator will send a status update signal to the cloud processing platform acknowledging receipt of the IMN command signal, thereby indicating that the commanded movement is performable and that the barrier operator will attempt to perform the IMN. At process 214, the barrier operator performs the IMN. This may include instructing an alert module to emit a series of light flashes and/or sounds for predefined period of time. A barrier control module may directly control the alert module to conduct the IMN or may instruct a door controller that, in turn, controls the alert module.

At process 216, the barrier operator sends an acknowledgement signal to the cloud processing platform indicating that the IMN has been performed. That is, upon completion of the IMN, the barrier control module may generate the acknowledgement signal and instruct a Wi-Fi transceiver module on the barrier operator 120 to send the signal. At process 218, in response to receiving the acknowledgement signal, the cloud processing platform sends a barrier movement command signal to the barrier operator. At process 220, the barrier operator receives the barrier movement command signal from the cloud processing platform and executes the barrier movement command to move the barrier. This may include the barrier control module transmitting the barrier movement command signal to the barrier controller which, in turn, activates the motor to move the barrier.

It should be appreciated that, in some examples, the method 200 may be performed only for barrier movement requests received when the barrier is open and the request indicates an instruction to close the barrier. In this regard, barrier movement requests to transition the barrier from the closed position to open position may omit processes 204-220 in some examples.

In the description, specific details have been set forth describing some examples. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure.

Elements described in detail with reference to one example, example, implementation, or application optionally may be included, whenever practical, in other examples, implementations, or applications in which they are not specifically shown or described. For example, if an element is described in detail with reference to one example and is not described with reference to a second example, the element may nevertheless be claimed as included in the second example. Thus, to avoid unnecessary repetition in the foregoing description, one or more elements shown and described in association with one example, implementation, or application may be incorporated into other examples, implementations, or application unless specifically described otherwise, unless the one or more elements would make an example or implementation non-functional, or unless two or more of the elements provide conflicting functions. Similarly, it should be understood that any particular element, including a system component or a method process, is optional and is not considered to be an essential feature of the present disclosure unless expressly stated otherwise.

Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure. In addition, dimensions and temporal relationships provided herein are for providing specific examples and it is contemplated that different sizes, dimensions, relationships and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The methods described herein are illustrated as a set of operations or processes. Not all the illustrated processes may be performed in all examples of the methods. Additionally, one or more processes that are not expressly illustrated or described may be included before, after, in between, or as part of the example processes. In some examples, one or more of the processes may be performed by a controller and/or may be implemented, at least in part, in the form of executable code stored on non-transitory, tangible, computer or machine-readable media that when run by one or more processors may cause the one or more processors to perform one, some, or all the processes described in relation to the methods herein. Elements illustrated in block diagrams herein may be implemented with hardware, software, firmware, or any combination thereof. One block element being illustrated separate from another block element does not necessarily require that the functions performed by each separate element requires distinct hardware or software but rather they are illustrated separately for the sake of description.

One or more elements in examples of this disclosure may be implemented in software to execute on one or more processors of a computer system such as a controller. When implemented in software, the elements of the examples of the present disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In one example, systems herein support wireless communication protocols such as RF, Bluetooth, IrDA, HomeRF, IEEE 802.11, DECT, and Wireless Telemetry.

Note that the presented devices and methods may not inherently be related to any particular computer or other apparatus. Various general-purpose systems may be used with programs in accordance with the teachings herein, or it may prove convenient to construct a more specialized apparatus to perform the operations described. The required structure for a variety of these systems will appear as elements in the claims. In addition, the examples of the present disclosure are not described with reference to any particular programming language. It will be appreciated that a variety of programming languages may be used to implement the teachings of the present disclosure.

In some instances, well-known methods, procedures, components, and circuits have not been described in detail so as not to unnecessarily obscure aspects of the examples.

While certain exemplary examples of the present disclosure have been described and shown in the accompanying drawings, it is to be understood that such examples are merely illustrative of and not restrictive on the broad disclosure herein, and that the examples of the present disclosure should not be limited to the specific constructions and arrangements shown and described, since various other modifications may occur to those ordinarily skilled in the art.

What is claimed is:

1. A barrier operator for manipulating a barrier, the barrier operator configured to:
receive an imminent motion notification command from a server;
perform an imminent motion notification;
in response to completing the imminent motion notification, send an acknowledgement signal to the server indicating that the imminent motion notification has been performed;
after sending the acknowledgement signal, receive a barrier movement command from the server; and
in response to receiving the barrier movement command, move the barrier.

2. The barrier operator of claim 1, wherein the barrier operator is further configured to:
assess, after receiving the imminent motion notification command from the server, whether a commanded movement of the barrier is performable.

3. The barrier operator of claim 2, wherein the barrier operator is further configured to:
send an indication of a result of assessing whether the commanded movement of the barrier is performable to the server.

4. The barrier operator of claim 3, wherein the barrier operator is configured to send the indication prior to or simultaneously with performing the imminent motion notification.

5. The barrier operator of claim 2, wherein the barrier operator is configured to:
assess that the commanded movement of the barrier is performable by determining whether an obstruction is detected by an optical sensor.

6. The barrier operator of claim 2, wherein the barrier operator is configured to assess that the commanded movement of the barrier is performable by verifying the barrier operator is not in an error state.

7. The barrier operator of claim 2, wherein the barrier operator is configured to assess that the commanded movement of the barrier is performable by verifying that the barrier is in a position that will allow execution of the commanded movement.

8. The barrier operator of claim 2, wherein the commanded movement of the barrier is transitioning from an open position to a closed position.

9. The barrier operator of claim 1, wherein the barrier operator is further configured to:
assess, after receiving the barrier movement command, whether a commanded movement of the barrier is performable; and
send an indication of a result of determining whether the commanded movement of the barrier is performable to the server.

10. The barrier operator of claim 1, wherein the barrier operator is configured to communicate with the server over a wireless network via an internet router.

11. The barrier operator of claim 1, wherein the barrier operator comprises a barrier control module including at least one first processor and configured to communicate with the server and a barrier controller including at least one second processor configured to control movement of the barrier.

12. The barrier operator of claim 11, wherein the at least one first processor is configured to command the at least one second processor perform the imminent motion notification.

13. The barrier operator of claim 11, further comprising a housing, wherein the barrier control module and the barrier controller are disposed within the housing.

14. The barrier operator of claim 1, wherein the barrier operator is configured to, after moving the barrier, transmit a signal to the server indicating that a commanded movement of the barrier has been completed.

15. A server in communication with a barrier operator, wherein the server is configured to:
receive a message from a remote user device indicating a request to move a barrier controlled by the barrier operator;
send an imminent motion notification command to the barrier operator in response to receipt of the message from the remote user device;
receive an acknowledgement signal from the barrier operator indicating the imminent motion notification has been performed; and
send a barrier movement command to the barrier operator in response to receiving the acknowledgement signal.

16. The server of claim 15, wherein the server is configured to initiate a time-out function in response to sending the imminent motion notification command, the time-out function including a predefined period of time.

17. The server of claim 16, wherein the server is configured to discard the barrier movement command, without sending the barrier movement command to the barrier operator, if the acknowledgement signal is not received within the predefined period of time.

18. A barrier operator system, comprising:
a barrier operator including:
a motor configured to manipulate a barrier;
an alert module;
one or more processors configured to control the motor and the alert module;
and
a server, wherein the barrier operator system is configured to:
receive, at the server, a message from a remote user device indicating a request to move the barrier;
send, by the server, an imminent motion notification command to the barrier operator;
perform, by the barrier operator in response to receipt of the imminent motion notification command, an imminent motion notification;
send, by the barrier operator, an acknowledgement signal to the server indicating that the imminent motion notification has been performed;
send, by the server in response to receipt of the acknowledgement signal, a barrier movement command to the barrier operator; and
operate, by the barrier operator, the motor to execute the barrier movement command.

19. The barrier operator system of claim 18, wherein the barrier operator is configured to assess, before executing the imminent motion notification command, that a commanded movement of the barrier is performable.

20. The barrier operator system of claim 18, wherein the barrier operator is configured to transmit to the server, after executing the barrier movement command, a signal indicating that the barrier has been moved.
